(19) United States
(12) Patent Application Publication
(10) Pub. No.: US 2007/0025831 A1
(43) Pub. Date: Feb. 1, 2007

(54) Rail car loading apparatus

(76) Inventors: Barry Burt, Regina (CA); Neil Marcotte, Regina (CA)

Correspondence Address: FROST BROWN TODD, LLC, 2200 PNC CENTER, 201 E. FIFTH STREET, CINCINNATI, OH, 45202, US

(21) Appl. No.: 11/192,816

(22) Filed: Jul. 29, 2005

(51) Int. Cl. B65F 9/00

(52) U.S. Cl. 414/339

(57) ABSTRACT

A rail car loading apparatus includes a flat bed rail car attachable at a front end thereof to a rear end of an adjacent rail car. A front wheel set is mounted under the front end of the flat bed rail car to support the front end of the flat bed rail car on track rails, and a rear wheel set is mounted under a rear end of the flat bed rail car to support the rear end of the flat bed rail car on the track rails. The flat bed rail car is movable from a transport position wherein a top surface thereof is substantially horizontal, to a loading position wherein the top surface thereof is inclined downward from the front end thereof to the rear end thereof. The rear wheels can slide forward to allow the rear end to drop down to the loading position.

This invention is in the field of railroad equipment and in particular equipment for loading railroad vehicles on rail cars for transport.

### BACKGROUND OF THE INVENTION

Railroad maintenance often involves a number of various pieces of equipment mounted on rail vehicles following one another in a string along a railway track with each piece of equipment performing its function in turn at any given portion of the rail bed. For example replacement of ties can require a first machine to remove defective ties, followed by a second machine to insert new ties in place of the removed ties, and followed in turn by a third machine to tamp the new ties in place, and perhaps by a fourth machine to spike the rails to the new ties.

While this string of vehicles is working on a rail bed, regular train traffic on the railway track is not possible. Such equipment is typically hauled to the work site on flat cars or the like and lifted from the flat cars to the railway track by a crane or the like. It is a time-consuming operation to place all the required machines in a string to perform a maintenance operation, and so it is not practical to remove the machines before the work at the site is complete.

Ramps are well known for installation on the rear ends of flat cars for loading road vehicles such as trucks and the like. Such ramps are disclosed for example in U.S. Pat. No. 6,718,886 to Eagle, U.S. Pat. No. 6,682,294 to Carroll, and U.S. Pat. No. 5,802,983 to Manzini.

U.S. Pat. Nos. 5,443,353 and 5,697,754 to Raymer disclose folding ramps for mounting on the end of a flat car or the like for loading rail vehicles. The ramps and rail car include loading rails on a top surface thereof, and the ramps are suitable for allowing rail vehicles to be driven or pulled on the loading rails up the ramp and onto the flat car.

Once a rail vehicle is loaded on the flat car with attached ramp as in Raymer, the rail vehicle can be moved onto an adjacent car by providing a bridge across the gap between the ends of the loading rail on each car. U.S. Pat. No. 138,476 to Caldwell also discloses loading rails on flat cars that are oriented such that a rail vehicle can roll on the rails from one car to the next.

The ramps disclosed by Raymer are of significant length in order to provide a low angle for loading rail vehicles. The length requires that a relatively complex folding mechanism be provided to store the ramps.

### SUMMARY OF THE INVENTION

It is an object of the present invention to provide a rail car loading apparatus that overcomes problems in the prior art.

The present invention provides, in a first embodiment, a rail car loading apparatus comprising a flat bed rail car attachable at a front end thereof to a rear end of an adjacent rail car. A front wheel set is mounted under the front end of the flat bed rail car to support the front end of the flat bed rail car on track rails, and a rear wheel set is mounted under a rear end of the flat bed rail car to support the rear end of the flat bed rail car on the track rails. The flat bed rail car is movable from a transport position wherein a top surface thereof is substantially horizontal, to a loading position wherein the top surface thereof is inclined downward from the front end thereof to the rear end thereof.

The present invention provides, in a second embodiment, a rail car loading apparatus comprising a flat bed rail car attachable at a front end thereof to a rear end of an adjacent rail car. A front wheel set is mounted under the front end of the flat bed rail car to support the front end of the flat bed rail car on track rails. A rear wheel set is slidably mounted under the flat bed rail car such that the rear wheel set is movable from a rear position under a rear end of the flat bed rail car supporting the rear end of the flat bed rail car on track rails, to a forward position adjacent the front wheel set. A lowering mechanism is mounted on the flat bed rail car and is operative to support the flat bed rail car in a substantially horizontal position, and is operative, when the rear wheel set is in the forward position, to lower the rear end of the flat bed rail car to a loading position wherein the top surface of the flat bed rail car is inclined downward from the front end thereof to the rear end thereof. A ramp member is mounted at the rear end of the flat bed rail car and is movable from a raised position resting on the rear end of the flat bed rail car, to a lowered position wherein a rear end of the ramp member is resting on the track rails.

By tilting the entire length of the flat bed rail car, the invention provides a strong ramp with a relatively shallow grade suitable for loading heavy vehicle. Loading rails can be provided to allow loading of heavy rail vehicles.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the rail car loading apparatus in the transport position;

FIG. 2 is a perspective view of the embodiment of FIG. 1 with the ramp member extended;

FIG. 3 is a side view of the embodiment of FIG. 1 in the transport position;

FIG. 4 is a side view of the embodiment of FIG. 1 with the rear wheel set partially moved toward the forward position.

FIG. 5 is a side view of the embodiment of FIG. 1 in the loading position;

FIG. 6 is a side view showing the rear ends of the ramp portion of the loading rails resting on the track rails;

FIG. 7 is a top view showing the rear ends of the ramp portion of the loading rails resting on the track rails.

### DETAILED DESCRIPTION OF THE ILLUSTRATED EMBODIMENTS

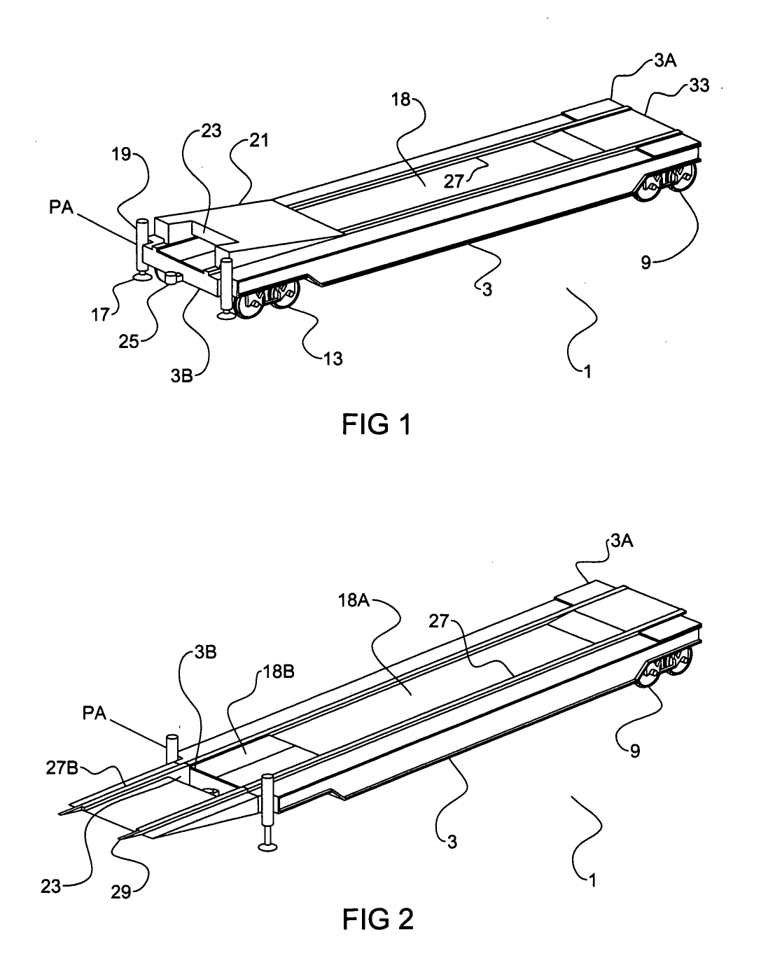

FIGS. 1-5 schematically illustrate a rail car loading apparatus 1 of the present invention comprising a flat bed rail car 3 attachable at a front end 3A thereof to the rear end of an adjacent rail car 7. A front wheel set 9, illustrated as a typical railcar truckset, is mounted under the front end 5 to support the front end of the flat bed rail car on track rails 11. A rear wheel set 13 supports the rear end 3B of the flat bed rail car 3, and is slidably mounted under the flat bed rail car 3 such that the rear wheel set 13 is movable from a rear position under the rear end of the flat bed rail car, as illustrated in FIG. 2, to a forward position adjacent the front wheel set 9 as illustrated in FIG. 4.

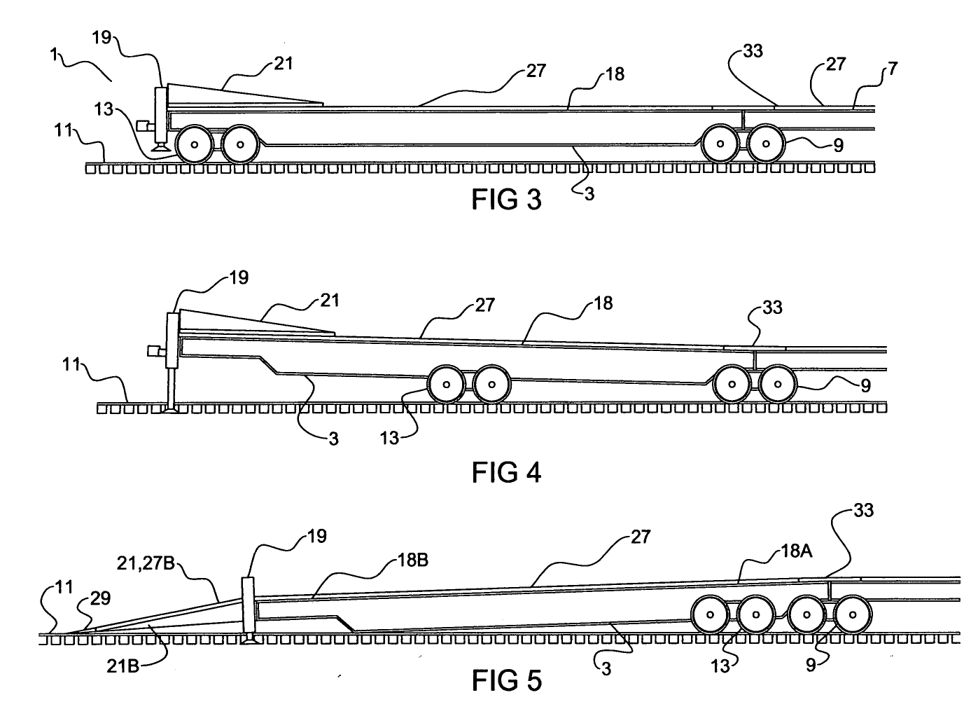

The flat bed rail car 3 is movable from a transport position illustrated in FIG. 3, wherein a top surface 15 thereof is substantially horizontal and the rear wheel set 13 is in the rear position, to a loading position illustrated in FIG. 5, wherein the top surface 15 thereof is inclined downward from the front end 3A thereof to the rear end 3B thereof and the rear wheel set 13 is in the forward position. The rear wheel set 13 is moved to the forward position to allow the flat bed rail car 3 to move from the transport position to the loading position.

A lowering mechanism 17 is mounted on the flat bed rail car and is operative to support the rear end of the flat bed rail car when the rear wheel set 13 is sliding toward the forward position, as illustrated in FIG. 4, and then is operative to lower the rear end 3B of the flat bed rail car 3 when the rear wheel set 13 is in the forward position. In the illustrated embodiment, the lowering mechanism 17 comprises an extendable actuator 19 mounted in a vertical orientation on each side of the flat bed rail car 3 in proximity to the rear end 3B thereof. The actuators 19 are extended in FIG. 4 to raise the rear end 3B of the flat bed rail car 3 slightly when sliding the rear wheel set 13 to the forward position such that no weight bears down on the rear wheel set 13. The actuators 19 are retracted as shown in FIG. 5 to lower the rear end 3B of the flat bed rail car 3 to the loading position.

A chain mechanism or the like can be used to move the rear wheel set 13 forward and backward along channels or the like. With the weight raised off the rear wheel set 13, they roll readily back and forth along the track rails 11. The underside of the flat bed rail car 3 is configured such that same can move downward with respect to the rear wheel set 13 when the wheels set is in the forward position of FIG. 5.

Once the flat bed rail car 3 is in the inclined loading position of FIGS. 2 and 5, it is contemplated that a portable ramp assembly could be put in a position sloping between the top of the rear end 3B of the flat bed rail car 3 and the top of the track rails to allow a vehicle to be rolled up onto the flat bed rail car 3. In order to reduce the height of the rear end 3B of the flat bed rail car 3 in the loading position, the top surface 18 of the illustrated flat bed rail car comprises a substantially horizontal front bed section 18A, and an inclined rear bed section 18B inclined downward from a rear end of the front bed section.

The illustrated apparatus 1 however provides a ramp member 21 mounted at the rear end 3B of the flat bed rail car 3. The ramp member 21 is movable from a raised position resting on the rear end 3B of the flat bed rail car 3, as illustrated in FIGS. 3, and 4, to a lowered position wherein a rear end of the ramp member 21B is resting on the track rails 11, as illustrated in FIG. 5. The illustrated ramp member 21 is pivotally attached at a front end thereof to the rear end of the rear bed section 18B about a substantially horizontal pivot axis PA oriented substantially perpendicular to the track rails 11.

In order to support the ramp member 21 for carrying heavy vehicles, the ramp member 21 is configured such that at least a middle portion of the ramp member 21 between the rear end and the pivot axis PA rests on and is supported by the track rails 11. The illustrated ramp member 21 is configured such that, as illustrated in FIG. 5, substantially the whole of the bottom side of thereof rests on the track rails 11. With this support, the ramp member 21 can be made lighter than would be possible if it was required to support a load over a considerable span.

As can be seen in FIG. 5, the ramp member 21 and inclined rear bed section 18B are configured such that when the ramp member 21 is in the lowered position resting on the track rails 11 the ramp member and inclined rear bed section 18B are substantially aligned such that a vehicle rolling from the track rails 11 first moves up a first grade, provided by the ramp member 21 and inclined rear bed section 18B, and then moves onto the front bed section 18A that is oriented at a lesser grade. The grades can vary with any particular application, however in the illustrated embodiment the first grade is about 13% and the second grade is about 5%. Thus by tilting the entire length of the flat bed rail car 3, the apparatus 1 provides a lengthy ramp for loading vehicles that allows for a relatively shallow grade to facilitate loading heavy vehicles. The loading apparatus 1 also has considerable strength, since the flat bed rail car 3 itself provides the ramp.

A coupler 25 is provided on the rear end 3B of the flat bed rail car 3 for attaching a rail car behind if required. To accommodate the coupler, the front end of the ramp member 21 defines a recess 23 configured such that when the ramp member 21 is in the lowered position the coupler 25 is located in the recess 23, as illustrated in FIG. 2.

While the invention could provide a loading apparatus suitable for loading road vehicles such as trucks, the illustrated apparatus 1 also comprises a set of loading rails 27 mounted along the top surface 18 of the flat bed rail car and a top surface of the ramp member 21. A ramp portion 27B of the loading rails 27 is mounted on the ramp member 21. The apparatus is configured such that when the ramp member 21 is lowered and aligned with the inclined rear bed section 18B the corresponding ends of the loading rails 27 on each are in close proximity and aligned.

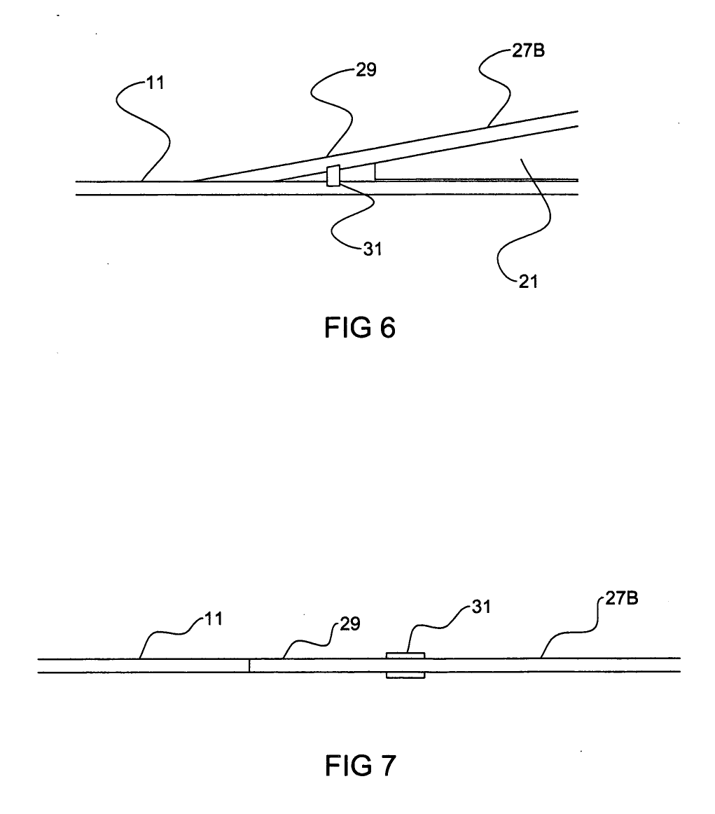

Rear ends 29 of the ramp portion 27B of the loading rails are configured, as illustrated in FIG. 6, such that a top of the loading rails 29 substantially coincides with a top of the track rails 11 when the ramp member 21 is in the lowered position, such that a rail vehicle can move from the track rails 11 onto the loading rails 27 and move up the ramp member 21 and along the flat bed rail car 3. As illustrated in FIGS. 6 and 7, guides 31 can be mounted on the ramp portion 27B of the loading rails or on the ramp member 21 to maintain the rear ends 29 of the ramp portion 27B of the loading rails in alignment with the track rails 11.

In the illustrated embodiment the front end of the flat bed rail car 3 is adapted for attachment to an adjacent rail car 7 that also has loading rails 27 on a top surface thereof. A bridge section 33 can be placed over the gap between the flat bed rail car 3 and the adjacent rail car 7, or a like mechanism can be provided, such that a rail vehicle can move on the loading rails 27 from the flat bed rail car 3 to the adjacent rail car. Similar bridging mechanisms can be provided where the apparatus 1 is used for loading road vehicles such as trucks and the like.

It is also contemplated that where desired, a rail vehicle could be driven up onto the loading rails on the flat bed rail car 3, and then the actuators 19 could be extended to raise the rear end 3B of the flat bed rail car 3 and the rear wheel set 13 then moved back to the rear position and the ramp member 21 folded back onto the flat bed rail car 3. The rail vehicle could then be transported on the flat bed rail car 3.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A rail car loading apparatus comprising:
a flat bed rail car attachable at a front end thereof to a rear end of an adjacent rail car;
a front wheel set mounted under the front end of the flat bed rail car to support the front end of the flat bed rail car on track rails;
a rear wheel set mounted under a rear end of the flat bed rail car to support the rear end of the flat bed rail car on the track rails;
wherein the flat bed rail car is movable from a transport position wherein a top surface thereof is substantially horizontal, to a loading position wherein the top surface thereof is inclined downward from substantially the front end thereof to the rear end thereof.

2. The apparatus of claim 1 wherein the rear wheel set is slidably mounted under the flat bed rail car such that the rear wheel set is movable from a rear position under a rear end of the flat bed rail car to support the rear end of the flat bed rail car on the track rails when in a rear position, to a forward position adjacent the front wheel set, and wherein the rear wheel set is moved to the forward position to allow the flat bed rail car to move from the transport position to the loading position.

3. The apparatus of claim 2 a lowering mechanism mounted on the flat bed rail car and operative to support the rear end of the flat bed rail car when the rear wheel set is sliding toward the forward position, and operative to lower the rear end of the flat bed rail car when the rear wheel set is in the forward position.

4. The apparatus of claim 3 wherein the lowering mechanism comprises at least one extendable actuator movable from a first position wherein the flat bed rail car is supported by the lowering mechanism substantially in the transport position, to a second position wherein the flat bed rail car is in the loading position.

5. The apparatus of claim 4 comprising an extendable actuator mounted in a substantially vertical orientation on each side of the flat bed rail car in proximity to the rear end of the flat bed rail car, and wherein the actuators are extended to raise the rear end of the flat bed rail car when sliding the rear wheel set to the forward position, and retracted to lower the rear end of the flat bed rail car to the loading position.

6. The apparatus of claim 1 further comprising a ramp member mounted at the rear end of the flat bed rail car and movable from a raised position resting on the rear end of the flat bed rail car, to a lowered position wherein a rear end of the ramp member is resting on the track rails.

7. The apparatus of claim 6 wherein the ramp member is pivotally attached at a front end thereof to the rear end of the flat bed rail car about a substantially horizontal pivot axis oriented substantially perpendicular to the track rails.

8. The apparatus of claim 7 wherein the top surface of the flat bed rail car comprises a substantially horizontal front bed section, and an inclined rear bed section inclined downward from a rear end of the front bed section, and wherein the pivot axis is located at a rear end of the rear bed section.

9. The apparatus of claim 7 further comprising a coupler on a rear end of the flat bed rail car, and wherein a front end of the ramp member defines a recess configured such that when the ramp member is in the lowered position the coupler is located in the recess.

10. The apparatus of claim 6 further comprising a set of loading rails mounted along the top surface of the flat bed rail car and a top surface of the ramp member such that a rail vehicle can move on the loading rails up the ramp member and along the flat bed rail car.

11. The apparatus of claim 10 wherein a ramp portion of the loading rails is mounted on the ramp member, and wherein rear ends of the ramp portion of the loading rails are configured such that a top of the loading rails substantially coincides with a top of the track rails when the ramp member is in the lowered position.

12. The apparatus of claim 11 further comprising guides operative to maintain the rear ends of the ramp portion of the loading rails in alignment with the track rails.

13. The apparatus of claim 10 wherein a middle portion of the ramp member rests on and is supported by the track rails.

14. The apparatus of claim 10 wherein the front end of the flat bed rail car is adapted for attachment to an adjacent rail car that comprises loading rails on a top surface thereof, and wherein the attachment is such that a rail vehicle can move on the loading rails from the flat bed rail car to the adjacent rail car.

15. The apparatus of claim 1 wherein the front end of the flat bed rail car is adapted for attachment to an adjacent rail car such that a wheeled vehicle can drive from the flat bed rail car onto the adjacent rail car.

16. A rail car loading apparatus comprising:
a flat bed rail car attachable at a front end thereof to a rear end of an adjacent rail car;
a front wheel set mounted under the front end of the flat bed rail car to support the front end of the flat bed rail car on track rails;
a rear wheel set slidably mounted under the flat bed rail car such that the rear wheel set is movable from a rear position under a rear end of the flat bed rail car supporting the rear end of the flat bed rail car on track rails, to a forward position adjacent the front wheel set;
a lowering mechanism mounted on the flat bed rail car and operative to support the flat bed rail car in a substantially horizontal position, and operative, when the rear wheel set is in the forward position, to lower the rear end of the flat bed rail car to a loading position wherein the top surface of the flat bed rail car is inclined downward from substantially the front end thereof to the rear end thereof; and
a ramp member mounted at the rear end of the flat bed rail car and movable from a raised position resting on the rear end of the flat bed rail car, to a lowered position wherein a rear end of the ramp member is resting on the track rails.

17. The apparatus of claim 16 wherein the lowering mechanism comprises an extendable actuator mounted in a substantially vertical orientation on each side of the flat bed rail car in proximity to the rear end of the flat bed rail car, and wherein the actuators are extended to raise the rear end of the flat bed rail car when sliding the rear wheel set to the forward position, and retracted to lower the rear end of the flat bed rail car to the loading position.

18. The apparatus of claim 16 wherein the ramp member is pivotally attached at a front end thereof to the rear end of the flat bed rail car about a substantially horizontal pivot axis oriented substantially perpendicular to the track rails.

19. The apparatus of claim 18 wherein the top surface of the flat bed rail car comprises a substantially horizontal front bed section, and an inclined rear bed section inclined downward from a rear end of the front bed section, and wherein the pivot axis is located at a rear end of the rear bed section.

20. The apparatus of claim 18 further comprising a coupler on a rear end of the flat bed rail car, and wherein a front end of the ramp member defines a recess configured such that when the ramp member is in the lowered position the coupler is located in the recess.

21. The apparatus of claim 16 further comprising a set of loading rails mounted along the top surface of the flat bed rail car and the ramp member such that a rail vehicle can move on the loading rails up the ramp member and along the flat bed rail car.

22. The apparatus of claim 21 wherein a rear portion of the loading rails is mounted on the ramp member, and wherein rear ends of the rear portion of the loading rails are configured such that a top of the loading rails substantially coincides with a top of the track rails when the ramp member is in the lowered position.

23. The apparatus of claim 21 further comprising guides operative to maintain the rear ends of the ramp portion of the loading rails in alignment with the track rails.

24. The apparatus of claim 16 wherein a middle portion of the ramp member rests on and is supported by the track rails.

25. The apparatus of claim 21 wherein the front end of the flat bed rail car is adapted for attachment to an adjacent rail car that comprises loading rails on a top surface thereof, and wherein the attachment is such that a rail vehicle can move on the loading rails from the flat bed rail car to the adjacent rail car.

26. The apparatus of claim 16 wherein the front end of the flat bed rail car is adapted for attachment to an adjacent rail car such that a wheeled vehicle can drive from the flat bed rail car onto the adjacent rail car.
